(19) United States
(12) Patent Application Publication
(10) Pub. No.: US 2014/0344004 A1
(43) Pub. Date: Nov. 20, 2014

(54) WORK MANAGEMENT IN A NETWORK ENVIRONMENT

(71) Applicant: VENUGOPAL SURENDRAN, CUPERTINO, CA (US)

(72) Inventor: VENUGOPAL SURENDRAN, CUPERTINO, CA (US)

(21) Appl. No.: 13/893,384

(22) Filed: May 14, 2013

(51) Int. Cl. G06Q 10/06

(52) U.S. Cl. CPC G06Q 10/06316
USPC 705/7.26

(57) ABSTRACT

A method for work management in a network environment is provided and includes classifying data associated with a work into a plurality of work elements, determining a chronological order of the work elements, including by identifying a time of creation of each work element, determining relationships between the work elements, determining a relative importance of each work element, and displaying the plurality of work elements as distinct icons on a graphical user interface (GUI) at a client in a network environment. The icons are configurable to be arranged according to the chronological order to indicate a story. Related work elements are clustered together and work elements with relatively higher importance are displayed as relatively larger icons. The work includes a software implementation of a collection of activities, information, and documents that together contribute to an overall business goal.

### TECHNICAL FIELD

This disclosure relates in general to the field of workflow and project management and, more particularly, to work management in a network environment.

### BACKGROUND

Project management systems and workflow management systems facilitate efficiency and high productivity in an organizational context. Project management systems permit planning, initiation, and execution of projects. In general, a project is a temporary endeavor with a defined beginning and end undertaken to meet certain goals and objectives. The project can include a series of tasks, some of which may constitute part of a workflow. In general, a workflow consists of a sequence of concatenated tasks. Workflow management systems manage and define the series of tasks within the organization to produce final outcomes. Workflow management systems allow users to define different workflows for different types of jobs. In some cases, workflow management systems also automate redundant tasks and ensure that uncompleted tasks are followed up.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a system for work management in a network environment according to one embodiment;

FIG. 2 is a simplified block diagram illustrating example details of the system in accordance with one embodiment;

FIG. 3 is a simplified diagram illustrating example details that may be associated with an embodiment of system;

FIG. 4A is a simplified diagram illustrating other example details that may be associated with an embodiment of system;

FIG. 4B is a simplified diagram illustrating other example details that may be associated with an embodiment of system;

FIG. 5A is a simplified diagram illustrating other example details that may be associated with an embodiment of system;

FIG. 5B is a simplified diagram illustrating other example details that may be associated with an embodiment of system;

FIG. 6 is a simplified diagram illustrating yet other example details that may be associated with an embodiment of system;

FIG. 7 is a simplified diagram illustrating yet other example details that may be associated with an embodiment of system;

FIG. 8 is a simplified diagram illustrating yet other example details that may be associated with an embodiment of system;

FIG. 9 is a simplified diagram illustrating yet other example details that may be associated with an embodiment of system;

FIG. 10 is a simplified diagram illustrating yet other example details that may be associated with an embodiment of system;

FIG. 11 is a simplified diagram illustrating yet other example details that may be associated with an embodiment of system;

FIG. 12 is a simplified diagram illustrating yet other example details that may be associated with an embodiment of system;

FIG. 13 is a simplified diagram illustrating yet other example details that may be associated with an embodiment of system;

FIG. 14 is a simplified diagram illustrating yet other example details that may be associated with an embodiment of system;

FIG. 15 is a simplified diagram illustrating yet other example details that may be associated with an embodiment of system;

FIG. 16A is a simplified diagram illustrating yet other example details that may be associated with an embodiment of system;

FIG. 16B is a simplified diagram illustrating yet other example details that may be associated with an embodiment of system

FIG. 17 is a simplified diagram illustrating yet other example details that may be associated with an embodiment of system;

FIG. 18 is a simplified diagram illustrating yet other example details that may be associated with an embodiment of system;

FIG. 19 is a simplified flow diagram illustrating example operations that may be associated with an embodiment of system;

FIG. 20 is a simplified flow diagram illustrating yet other example operations that may be associated with an embodiment of system; and

FIG. 21 is a simplified flow diagram illustrating yet other example operations that may be associated with an embodiment of system.

### DETAILED DESCRIPTION OF EXAMPLE EMBODIMENTS

### Overview

A method for work management in a network environment is provided and includes classifying data associated with a work into a plurality of work elements, determining a chronological order of the work elements, including by identifying a time of creation of each work element, determining relationships between the work elements, determining a relative importance of each work element, and displaying the plurality of work elements as distinct icons on a graphical user interface (GUI) at a client in a network environment. The icons are configurable to be arranged according to the chronological order to indicate a story. Related work elements are clustered together and work elements with relatively higher importance are displayed as relatively larger icons. The work includes a software implementation of a collection of activities, information, and documents that together contribute to an overall business goal.

In specific embodiments, the display includes a spatial view and a tabular view of the work elements. Types of work elements can include titles, tasks, insights, and one or more of attachments, questions, issues, discussions, notes, and links. Each type of work element may be associated with a respective icon. In some embodiments, each task may be displayed as a circular icon, shaded according to a percentage of completion, with associated work elements indicated as respective icons connected to the circular icon. The insights are associated with one or more tasks and linked according to keywords in the tasks. Each type of work element may be created using a respective editor on the GUI. For example, a discussion editor can be edited substantially simultaneously by a plurality of users, a notes editor can be edited by one user at any specific instant, a question editor can be edited by at least two users, and an issues editor can be edited by at least two users.

In specific embodiments, the display is filtered to show work elements associated with a specific user. The relative importance of the work elements are based on a relative position of the specific user in an organizational hierarchy. As used herein, the term “organizational hierarchy” refers to a social ordering wherein substantially every entity (e.g., employee, worker, etc.) in an organization (e.g., group, company, agency, team, etc.) is subordinate to at least one other entity. For example, work elements created by users higher in the organizational hierarchy are more important than work elements created by users lower in the organizational hierarchy. A default size of the icons can be based on the relative position of the specific user in the organizational hierarchy.

In some embodiments, the display can include a zoom function. When the display is zoomed in, the work elements show a portion of their respective content, and selecting the portion of a specific work element generates a more detailed view of the corresponding content. In specific embodiments, the display can be configured by a user to filter one or more details of the work elements. The relationships between the work elements may be based on keywords associated with the respective work elements.

### Example Embodiments

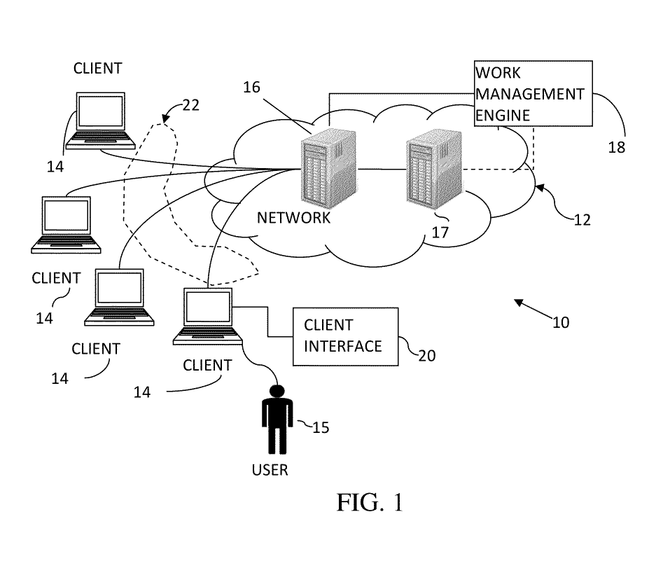

Turning to FIG. 1, FIG. 1 is a simplified block diagram illustrating a system 10 for work management in a network environment in accordance with one example embodiment. FIG. 1 illustrates a system 10 including a network 12 comprising one or more client(s) 14 controlled (or operated by) one or more user(s) 15. Network 12 can include a middle server 16 and a database server 17. Middle server 16 (and/or database server 17) can include a work management engine 18 that can communicate with a client interface 20 at client 14 to facilitate management of work 22 in network 12. As used herein, the term “work” includes a software implementation of a collection of activities (e.g., actions, behavior, events, etc.), information, and documents (e.g., files, folders, emails, etc.) that together contribute to an overall business goal. Work 22 encompasses a computerized facilitation or automation of a business process, in whole or part. Examples of work 22 include software development projects, factory operation, merger negotiations, database maintenance, news reporting, movie production, etc. Virtually any kind of activity, information and document can be included in a specific work.

As used herein, the term “server” encompasses a software program, or the computer on which that program executes, that provides a specific kind of service to clients (e.g., client 14) executing on the same computer or other computers communicating over a network (e.g., network 12). The term “client” encompasses a software program that accesses a service made available by a server (e.g., server 16). The term “user” includes a human operator who may access middle server 16 through client 14 and perform work 22. In various embodiments, different user(s) 15 may be associated with distinct authentication settings in system 10.

The authentication settings may serve to identify the specific user 15 and the user's respective role in the organization. For example, user 15 can include an individual software developer in the organization who may connect to network 12 using authentication settings (e.g., log-on credentials such as username and password) that indicate the user 15's organizational role of software developer; user 15 thus obtains access to files and computing resources available to software developers in the organization. Another user 15 may connect to network 12 using log-on credentials indicating a supervisor; user 15 thus obtains access to files and computing resources available to supervisors in the organization. Some user(s) 15 may have different access privileges compared to other user(s) 15. For example, the supervisor's access privileges may be different from the software developer's access privileges.

Moreover, some user(s) 15 may perform certain activities associated with work 22; other user(s) 15 may perform certain other activities; yet other user(s) 15 may perform the same activities in different contexts (e.g., test engineer 1 may test software after phase 1 of a project; test engineer 2 may test software after phase 2 of the project; etc.). Virtually any combination and scheduling of user(s) 15 may be associated with work 22 within the broad scope of the embodiments.

According to embodiments of system 10, work management engine 18 can facilitate user 15 to manage work 22 via respective client 14. Work management engine 18 can also help some user(s) 15 (e.g., managers, supervisors, etc. who are relatively higher up in an organizational hierarchy) track and manage work done by other user(s) 15's (e.g., factory workers, software developers, etc. who are relatively lower down in the organizational hierarchy). In some embodiments, virtually all user(s) 15 working on a specific work 22 can track work of everybody else involved in the same work 22. According to embodiments of system 10, work management engine 18 can enable a spatial view of the activities being executed in each work 22. Work management engine 18 can facilitate building a knowledge database gleaned from documents, activities, information and other content accessed through work management engine 18. In some embodiments, each work 22 may be viewed as a story unfolding, with the story's content authored by one or more user(s) 15.

For purposes of illustrating the techniques of system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Workflow can be described as the movement of documents and activities through a business process. Workflow can be a sequential progression of activities or a concurrent set of activities that impact each other according to predefined rules, routes, and roles. Various process-modeling techniques are available to define the detailed routing and processing requirements of a typical workflow. For example, a decision-chain process model uses milestones and decision points to map out the workflow.

Typical workflow management systems use one or more process-modeling techniques to allow organizations to define and control the various activities associated with a business process. In addition, many workflow management systems also allow the organization to measure and analyze the execution of the process so that continuous improvements can be made. Typical workflow management systems also integrate with other systems (e.g., document processing, databases, e-mail, office automation products, applications, etc.) used by the organization. The integration can provide a unified structure to a process that employs a number of otherwise independent systems.

Some typical features associated with many Workflow management systems include: process definition (a graphical or textual tool for defining the business process; each activity within the process is associated with a person or a computer application; rules are created to determine how the activities progress across the workflow and which controls are in place to govern each activity); simulation, prototyping and piloting (allow workflow simulation or prototype creation of a particular workflow so that it can be tried and tested on a limited basis before it goes into production); task initiation and control (engaging appropriate resources along the course of the project); rules based decision making; document routing; invocation of applications to view and manipulate data; work-lists (e.g., each user can quickly identify their current tasks along with due date, goal date, priority, etc.); task automation; event notification; distribution lists for messages; process monitoring (e.g., providing information on current workload, bottlenecks, turn-around time, missed deadlines, etc.); Internet access (e.g., allowing access to information for remote workers); tracking and logging; and administration and security.

Workflow management systems can be generally categorized into four categories: (1) production workflow management systems; (2) messaging-based workflow management systems; (3) web-based workflow management systems; and (4) suite-based workflow management systems. Production workflow management systems typically store documents in a central repository and provide check-in, check-out, and version control for the documents. Messaging-based workflow management systems typically route documents over existing e-mail systems. Web-based workflow management systems utilized a client-server paradigm over the Internet to deliver functionality. In suite-based workflow management systems, the applications (e.g., document processing, spreadsheet, e-mail, etc.) are integrated with the electronic mail system.

However, such workflow management systems have certain inherent problems. For example, production workflow management systems are generally more expensive than other systems, and may be platform dependent; messaging based workflow management systems are generally not comprehensive and flexible; web-based workflow management systems are typically complex and prone to security vulnerabilities; and suite based workflow management systems currently available may require high maintenance, or may have too little functionalities.

Another disadvantage of typical workflow management systems is the lack of access to information, for example, from corporate knowledge databases. More often than not, although corporate knowledge databases may be included in the workflow management systems, the information may be hard to access and/or retrieve in the context of a particular workflow. For example, the workflow management system may save documents pertaining to resolution of a specific issue that was encountered during project A. Project B, staffed by completely different persons may encounter the same issue several months later. Although the same issue was encountered previously in project A, nobody on project B knows about the issue without asking others in the organization. Even when the fact of the resolution's existence is realized, searching for the specific documents can be time-consuming, and a project in itself.

Moreover, each work handled by a team in an organization can involve nuances that are missed out in typical workflow management systems. For example, a project may face a roadblock and change directions as a result. The decision to change direction may be taken at a meeting and the meeting minutes may be captured and saved appropriately. Several months later, the details of the roadblock may be forgotten, or lost in the maze of information associated with the project. Senior management may ask for the reasons for the change in project direction, and much time and resources may be lost trying to retrieve the related meeting minutes. Because typical workflow management systems do not have a snap-shot view of a project as it unfolds in time, senior management, or auditors, or others interested in the project's history may have to spend a lot of time and resources trying to piece together the project story.

System 10 is configured to address these issues (and others) in offering a system and a method for work management in a network environment. Embodiments of system 10 can classify data associated with work 22 into a plurality of work elements, determine a chronological order of the work elements, including by identifying a time of creation of each work element, determine relationships between the work elements, determine a relative importance of each work element, and display the plurality of work elements as distinct icons on a graphical user interface (GUI) at client 14, for example, on client interface 20. In specific embodiments, the icons are configurable to be arranged according to the chronological order to indicate a story, related work elements are clustered together, and work elements with relatively higher importance are displayed as relatively larger icons.

Embodiments of system 10 can thus provide a visual representation of work 22 on the GUI of client interface 20. The visual representation can include a spatial view of work 22 displayed through icons as a story unfolding in time. The visual representation can include a time sequence of tasks, clusters (e.g., groups, bunches, etc.) of related tasks, and insights associated with the tasks, among other features. As used herein, the term “insight” refers to a summary of analysis performed on information related to work 22. Insights can include deep intuitive understanding, perception, penetration, grasp, discernment, observation, judgment, etc. of one or more aspects of work 22.

Embodiments of system 10 can facilitate displaying a spatial view of activities associated with each work 22. Work 22 may comprise one or more “work elements.” As used herein, the term “work elements” encompasses discrete and distinct activities associated with work 22, such as tasks (e.g., piece of work to be done or undertaken), questions, issues (e.g., problems, roadblocks, etc.), discussions, notes and insights. In some embodiments, work management engine 18 can facilitate building a knowledge base from insights entered by different user(s) 15. Different user(s) 15 in the organization may carry with them certain work related knowledge and experience. For example, a field level sales person knows that Customer A will respond well to discounts while Customer B responds better to additional products offered. A sales manager knows that Customer C responds better to integration. Both the sales person and the sales manager can input their insights into system 10. A sales vice president can view the related insights in the same or different context. The insights can provide much needed information to the sales vice president. System 10 can facilitate efficiency and productivity to the organization by capturing such insights and helping link related insights.

Work management engine 18 can provide task clustering through client interface 20. User(s) 15 at different levels in the organization can cluster related tasks together that can be viewed on client interface 20. User(s) 15 can place relevant notes or issues or questions or discussions near the related tasks. When tasks and other work elements are moved closer together (e.g., by dragging an associated icon with a mouse cursor), the work elements may form a cluster. The cluster of work elements can strengthen related concepts.

For example, imagine that three tasks (e.g., task 1, task 2, and task 3) are clustered together. All of tasks 1, 2 and 3 may relate to sales to “Customer A”. The cluster of tasks 1, 2 and 3 may strengthen “sales to Customer A” and related “Customer A” concepts. Meaningful information can be extracted from the clustered tasks and registered (e.g., entered, input, etc.) in close proximity to the clustered tasks, providing a visual understanding to others when the tasks are being viewed in the same or different context. Work management engine 18 can identify such concepts (e.g., concepts related to Customer A) and store references to the context in a central repository (e.g., database). Later on, a second user searching for how “Customer A” might respond to a sales campaign can search for references to Customer A. Work management engine 18 can show the second user the different clusters where “Customer A” concept is strong. The second user can learn more about Customer A by reading the related tasks, discussions, notes and issues.

In various embodiments, work management engine 18 can facilitate creating insights. Insights may be entered into work management engine 18, for example, based on analysis of task clustering. Work management engine 18 can also facilitate searching for insights, and linking insights in meaningful ways. For example, a cluster of tasks may be analyzed by a user and an insight may be entered indicating that Customer A does not buy any product for discounts less than 25%. The user may enter an insight near the task cluster on the GUI of client interface 20. The insight can mention that Customer A does not buy any product for discounts less than 25%. The insight can form a linked structure with other insights (e.g., Insight1 references Insight2 and Insight2 in turn references Insight1), for example, facilitating navigating to the linked insights from each other (e.g., navigating to Insight2 from Insight1 and vice versa).

Navigating the linked insights can provide a more accurate perspective of various issues encountered during performance of one or more work 22. The insights can be setup by user(s) 15 lower down in the organizational hierarchy or by user(s) 15 higher up the organizational hierarchy. For example, a vice president at a higher level in the organizational hierarchy can get a better understanding of the business and processes via the insights and a lower level sales representative can understand the overall strategy being adopted. User(s) 15 at different levels in the organizational hierarchy can make more informed decisions. Also, the insights can be available to other user(s) 15 in the organization as well. The insights can fuel more ideas, which can be input into work management engine 18 as new insights. Thus, the sum total of the knowledge in the organization can grow. The knowledge can be conveniently documented, saved and shared, all the while retaining its relationship to associated tasks, or clusters of tasks.

According to various embodiments, work management engine 18 can facilitate viewing work 22 as an unfolding story authored by user(s) 15 through respective clients 14. The story can include various work elements, clustered together as appropriate, including insights and other details placed in an appropriate time sequence. The story can have several advantages. For example, the story may be useful to understand the sequence of events that occurred in the project. Anyone reading the project story can understand why the project was implemented in a certain direction. They can understand why some tasks were taken off the priority list and some other tasks were added in. They can understand why Task 1 led to Task 2. They can understand the issues that came from attempting Task 1. The information can be used to generate greater efficiencies in the organization.

In various embodiments, user(s) 15 can interact with client interface 20 on respective clients 14. Client 14 can send queries to middle server 16 for data and receive the data back from middle server 16. In some embodiments, client 14 may not store any data locally on a hard drive or other such non-cache memory element. Middle server 16 may manage security, concurrency and servicing the query requirements of clients 14, among other functions. The data may be stored in back-end database server 17. Middle server 16 may send database-specific queries to back-end database server 17. Middle server 16 may compose an appropriate response to clients 14 when data is received from database server 17. The response may be sent to the requesting one of clients 14. In many embodiments, middle sever 16 may also store any customization data for each client 14 and/or user 15. Middle server 16 may send the customization data back to clients 14 upon request. In various embodiments, database server 17 can be any suitable relational database server, such as Oracle® database or SQL server or IBM® DB2 server, etc.

In various embodiments, work management engine 18 may be installed according to at least one of two modes: (1) full installation mode, where user 15 installs database server 17, middle server 16 and multiple clients for the different users; 2) subscription mode, where user(s) 15 can subscribe to the services provided by work management engine 18. In the subscription mode, user(s) 15 may install only client 14. Client 14 may connect to a central public middle server 16, similar to web-based client/server architecture. In the full installation mode, the data associated with work 22 remains exclusively within the customer's firewall, if any, or the customer's network. In the subscription mode, the data may be stored in a public server (e.g., middle server 16). However, security can be strictly enforced by middle server 16 to preserve the data's integrity, for example, so that customer 1 cannot see data belonging to customer 2.

In some embodiments, work management engine 18 can be integrated with e-mail applications. For example, user(s) 15 can setup alerts to be sent to them via e-mail. Merely for example purposes and not as limitations, alerts can be sent when one or more of the following scenarios occur: if any issue is created; if a tracked task has updates; any new work 22 is added; if a certain user 15 has added any updates; if any new insight is created; etc. User(s) 15 can also send data to work management engine 18 from e-mail applications. For example, user 15 can create a task in Microsoft Outlook® e-mail application and send it to work management engine 18. In some embodiments, plug-ins may be made available for standard e-mail clients like Microsoft Outlook; user(s) 15 can create different work elements using the plug-ins.

In some embodiments, work management engine 18 can support mobile applications. For example, client 14 can be ported to smart phones or other such mobile computing devices. User 15 can start client 14 from the smart phone. Client interface 20 on client 14 executing on the smart phone may be configured to provide the same visual experience as if client 14 were executing on a non-mobile computing device.

In specific embodiments, work management engine 18 can allow for management of work(s) 22 that spans multiple organizations. Thus, privileged user(s) 15 (e.g., users having special access privileges) in one organization can share work 22 with similarly privileged user(s) 15 in another organization. In some embodiments, user(s) 15 can setup the privileges. Thus, User1 in one company can indicate that User2 in another company can assign tasks to User1. User2 can also indicate that User1 can assign tasks to User2. For example, consider a scenario of three organizations: a restaurant, a farm produce supplier and a delivery company. The three organizations can create joint work 22 that tracks tasks affecting all three organizations. The restaurant may need certain supplies and could create suitable tasks pertaining to the supplies and assign to the farm produce company. The farm produce company could assign tasks to the delivery company to deliver the produce to the restaurant. The three organizations can track their tasks, raise questions, issues and take part in discussions. They can use the information gathered to create insights and bring further efficiency to their respective organizations and improve customer satisfaction.

In some embodiments, work management engine 18 can allow auto creation of tasks by pulling data from other applications. Further, user 15 can create custom views to display the data. For example, user 15 can create a custom view titled “All my open bugs”. By clicking on an appropriate view button on the GUI of client interface 20, user 15 can see the tasks that have been automatically created by work management engine 18. In some embodiments, the custom rule created for auto creation of the tasks, and the custom view may be made available to other users in the organization. The other users can simply pull the custom rule and custom view and start seeing their open bugs as well.

Turning to the infrastructure of system 10, the network topology can include any number of servers, routers, gateways, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs. System 10 may include a configuration capable of Transmission Control Protocol/Internet Protocol (TCP/IP) communications for the electronic transmission or reception of data packets in a network. System 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of system 10. It should be understood that the system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, work management 18 is an application that can execute on any suitable network element within network 12. As used herein, the term “network element” is meant to encompass computers, network appliances, servers, routers, switches, gateways, bridges, load-balancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

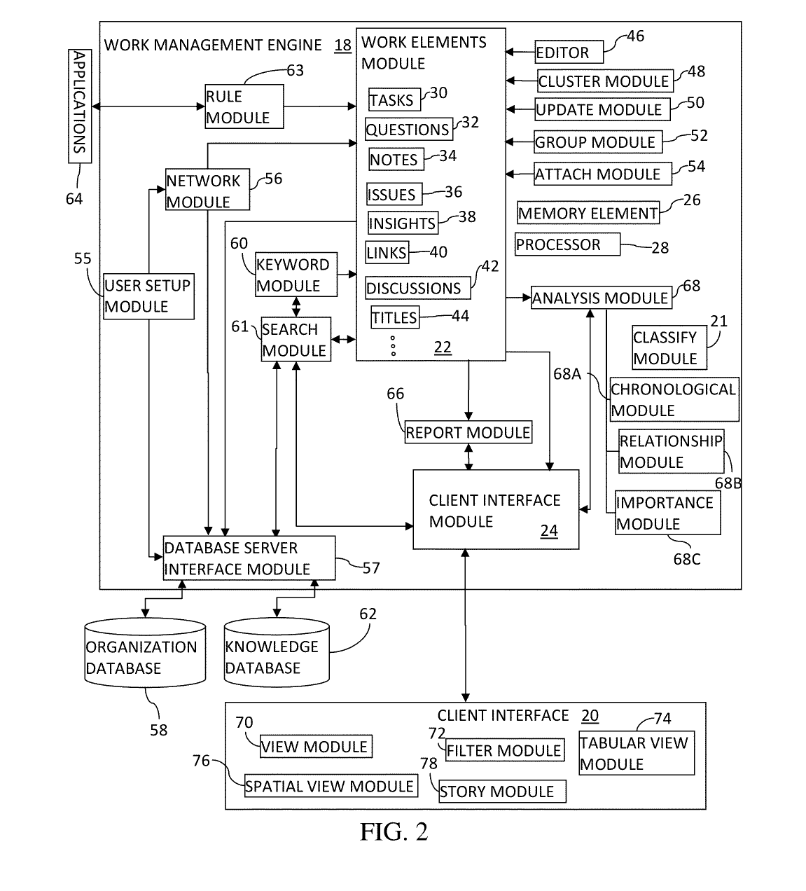

Turning to FIG. 2, FIG. 2 is a simplified block diagram illustrating example details of work management engine 18 according to an embodiment of system 10. Work management engine 18 can include a classify module 21, a work elements module 22, a client interface module 24, a memory element 26 and a processor 28. Classify module 21 may classify data associated with work 22 into one or more work elements. Work elements module 22 may comprise different types of work elements such as tasks 30, questions 32, notes 34, issues 26, insights 38, links 40, discussions 42, titles 44 and other custom work elements as appropriate. One or more editor 46 may be included in work management engine 18. Each type of work element may be associated with a respective icon. For example, tasks 30 may be associated with circle icons; issues 36 may be associated with icons having an exclamation mark; etc. The icons may be configured so that when user 15 views the GUI on client interface 20, different work elements may be identified quickly, by visual clues.

Links 40 can be set up by user(s) 15 to link work elements within a specific work and with other work within system 10. When user(s) 15 click on a specific link, the display of work 22 may split into two split panes in some embodiments. A first split pane may show the original view; the second split pane may open a field for work 22 where the linked work element exists. User(s) 15 can review the linked work element in the second split pane. Because user(s) 15 are looking at the field view, they can better understand a context of the linked work element and also browse nearby work elements as desired.

Titles 44 can be used to navigate or search for specific work 22. For example, a view button on a top panel of the GUI can indicate “All titles.” A left pane can show a tabular list of all titles in “Work: Title” format. User(s) 15 can quickly browse through the list and select the specific title of interest. A right pane can show the selected title and work elements associated with the title.

Work elements module 22 may also support custom work elements. User(s) 15 can create custom work elements and assign icons to them. Configurations of the custom work element can include icons (e.g., assigned to the work element), editors, and publishing network (e.g., network of user(s) 15 to whom the custom work element is replicated). For example, assume that work 22 can be enhanced by creating “Negotiation” as a custom work element. User A may create the custom work element and assign an appropriate icon to it. The custom work element may be published to the entire organization and all user(s) 15 can see “Negotiation” when they create new work elements. Work management engine 18 may facilitate creation of a view group called “Negotiation” in some embodiments. Inside the view group, certain default (e.g., standard) views may be generated (e.g., automatically). Examples of the standard views include “All negotiations assigned to me” or “All negotiations assigned to my reports”. User(s) 15 can customize the view group by adding or dropping or otherwise editing the views.

In various embodiments, the work elements may not have any specific hierarchy. Each work element may be as broad or inclusive as any other work element. For example, questions 32 may be attached to tasks 30, and vice versa. Moreover, each work element may exist independent of other work elements. For example, questions 32 may exist independent of tasks 30, and vice versa.

Each type of work element may be associated with a respective editor 46. For example, a discussion editor can be edited substantially simultaneously by a plurality of users; a notes editor can be edited by one user at any specific instant; a question editor can be edited by at least two users; an issues editor can be edited by at least two users. Many users can take part in a discussion and edit the discussions editor accordingly. For example, a specific user can type in a text associated with the discussion, and watch entries by other users in the same editor. The question editor can comprise two editor displays, with a top panel showing the question, and a bottom panel showing the answer. Many user(s) 15 can contribute to the answer. Editor 46 may be associated with any custom work element appropriately. For example, during configuration of the custom work element, the type of editor (e.g., single display, dual displays, etc.), the number of users allowed to edit using the editor, etc.

A cluster module 48 may facilitate combining related work elements into clusters (e.g., groups). Clustering may be performed manually (e.g., by one or more user(s) 15); clustering may also be performed automatically (e.g., by identifying related keywords or other relationship parameters). An update module 50 may facilitate updating work management engine 18 with appropriate updates as desired. A group module 52 may facilitate creating groups of work(s). For example, each user 15 can set up a group of work(s) 22 that may or may not be related. Each user 15 can create a group, name it suitably, and assign various work(s) 22 to the group. In some embodiments, the groups created by a specific user A may be visible to the specific user A and to substantially all other users in user A's network. Embodiments of system 10 may provide for creating groups with different access privileges (e.g., public, private, etc.). For example, if a group is created by user A with private privileges, the group may be visible only to user A and potentially to user A's managers/supervisors. An attach module 54 may facilitate associating attachments (e.g., documents from other applications such as Microsoft Word®; reports; etc.) with one or more work elements.

A user setup module 55 may permit user(s) 15 to configure work management engine 18 with their respective user information. User(s) 15 can configure their user information in work management engine 18, including specifying their relation to other user(s) 15 in the organizational hierarchy or system. For example, user W may configure his information. Later, user J, who is user W's subordinate, may configure his information. During configuration, user J may notice that user W is registered in work management engine 18 and indicate that user W is his manager. User W may decide to configure user P's information, as user P directly reports to user W in the organizational hierarchy.

The configuration information may be used by network module 56 to generate the organizational hierarchy. In some embodiments, the organizational hierarchy can be built by each user 15 configuring their respective user information, and specifying their respective relationships with other user(s) 15 in the organization. Thus, user J is linked to user P via user W; both users User P and user W may be inserted into user J's network. User W may be associated with additional access and editing privileges as User J's manager. User(s) 15 can also invite others in the organization to join. In one embodiment, the join invitation can be sent via e-mail. Network module 56 may thus facilitate determining a relative position of a specific user 15 in an organizational hierarchy and identifying the specific user 15's network. A database server interface module 57 may facilitate interfacing with an organization database 58, for example, that may be associated with database server 17 in network 12. The network information and the user configuration may be stored in organization database 58 for retrieval at a later time as desired.

A keyword module 60 may facilitate identifying, extracting and searching for keywords (among other functions). In an example embodiment, keyword module 60 may associate one or more insights 38 with one or more work elements based on keywords identified in the respective work elements. Related insights 38 may be searched for and identified based on keywords. In an example, when tasks 30 are clustered together, keyword module 60 may look at the keywords in tasks 30 and find insights 38 that have related keywords. Each one of insights 38 may show the keywords associated with the respective insight.

Merely for example purposes, and not as a limitation, assume that user J creates a first insight. Keyword module 60 may scan nearby (e.g., related, clustered) tasks 30 and identify certain keywords that could be associated with the first insight. User J can correct the list of keywords and prune away keywords that are not relevant and also add his own. Later, user P may add a second insight. As before with user J, keyword module 60 may identify potentially relevant keywords for user P's review. User P can select the relevant keywords as appropriate. Keyword module 60 can scan related insights that have similar keywords. User P can attach the related insights he feels are relevant.

In various embodiments, a number of keywords can grow over time as different user(s) 15 contribute their share of keywords. A library (or database, or other such similar storehouse) of keywords can help user(s) 15 to identify coherent keywords. For example, user A may find a keyword “memory fragmentation” in the keyword library. User A may add the keyword to his relevant list instead of creating another keyword titled “Fragmentation of memory”. In a specific embodiment, keyword module 60 can also scan tasks 30, discussions 42, notes 34, issues 36 and other suitable work elements for keywords in background threads.

For example, assume that user A creates work elements and saves the work elements without adding any keywords. Keyword module 60 may scan the text in the work elements for any matching keywords from its library of keywords and can update the keyword fields in both the work elements and the library of keywords appropriately. When user A or another user, say user B, opens the work elements at a later time, they can see that the keyword section has been updated by keyword module 60. They can manually prune out any keywords that may be irrelevant, and/or add in their own keywords. In some embodiments, manual editing may over-ride the automatic keyword association.

A search module 61 may facilitate searching for the keywords. For example, a search query may inquire for a specific keyword. Search module 61 may request database server interface module 57 to retrieve the keyword and related keywords and work elements from a knowledge database 62. Knowledge database 62 may include substantially all information associated with the work elements, including attachments, customizations, and other details for substantially all work 22 included in system 10.

A rule module 63 may provide for creating custom tasks, for example, to interface with external applications 64. Rules to create the custom tasks may be encapsulated in custom rules. For example, work 22 can include developing a mechanism to create and edit software bugs in a specific application. User(s) 15 may access the bugs from a web browser in a normal course of operation. User 15 can setup auto task creation that pulls the bug information when a bug is assigned to user 15. User 15 can setup templates indicating to rule module 63: 1) how to access data from the application; 2) how the returned data looks like; and 3) the specific work 22 in which to auto create the tasks. User 15 can setup a web-based uniform resource location (URL) through work management engine 18 to access the application using the user's login credentials (e.g., username/password). Rule module 63 can access the URL and pull the bug data from the application. Based on the information provided by user 15, rule module 63 may parse the returned data and pick out the bug information appropriately based on the templates generated by user 15. Work management engine 18 may also automatically create suitable tasks associated with work 22.

A report module 66 may facilitate generating reports. For example, a “Generate Report” button in a specific view can be configured to generate a status report. A vice president hard pressed for time can simply select the view and hit the “Generate Report” button to obtain a full report for the view. The vice president can scan the report for any updates and other details. The report can be edited by user 15, saved, printed or sent via email to other user(s) 15.

An analysis module 68 may provide for analysis of the work elements as appropriate, for example, to drill down into details of a specific work element, or cluster of work elements. Analysis module 68 may include one or more sub-modules, such as chronological module 68A, relationship module 68B, and importance module 68C. Chronological module 68B may determine a chronological order of work elements in a selected view for display on client interface 20. The chronological order may be based on the time of creating the respective work elements, the time of updating the respective work elements, or other suitable time-based criterion. Relationship module 68B may determine a relationship between different work elements. Importance module 68C may determine a relative importance of a specific work element to user 15 who is currently viewing the work element on client interface 20. Various other analysis modules may also be included within the broad scope of the embodiments.

Client interface 20 may include a view module 70, a filter module 72, a tabular view module 74, a spatial view module 76, and a story module 78. View module 70 may facilitate displaying one or more details of work 22 in a tabular or spatial visual representation. Filter module 72 may facilitate filtering details of work 22 for display on the selected view according to view module 72. Tabular view module 74 may facilitate displaying a textual list of work elements according to the filter parameters set in filter module 72, and the view selected in view module 70. Spatial view module 76 may facilitate displaying a spatial view of work elements according to a selected one of the list of work elements in the tabular view of tabular module 72, the filter parameters set in filter module 72, and the view selected in view module 70. Story module 78 may facilitate displaying the work elements in the spatial view of spatial view module 76 as icons arranged in a chronological order, with appropriate labels and other textual and graphical explanation, to indicate a story unfolding in time.

According to some embodiments, substantially all user customizations may be stored at client 14. According to some other embodiments, substantially all user customizations may be stored at middle server 16. Thus, when user 15 logs in from a different client, user 15 may experience the same GUI and client interface 20 as before. For example, user A may create a custom view from his laptop. User A can experience the same custom view when user A logs in from his smart phone.

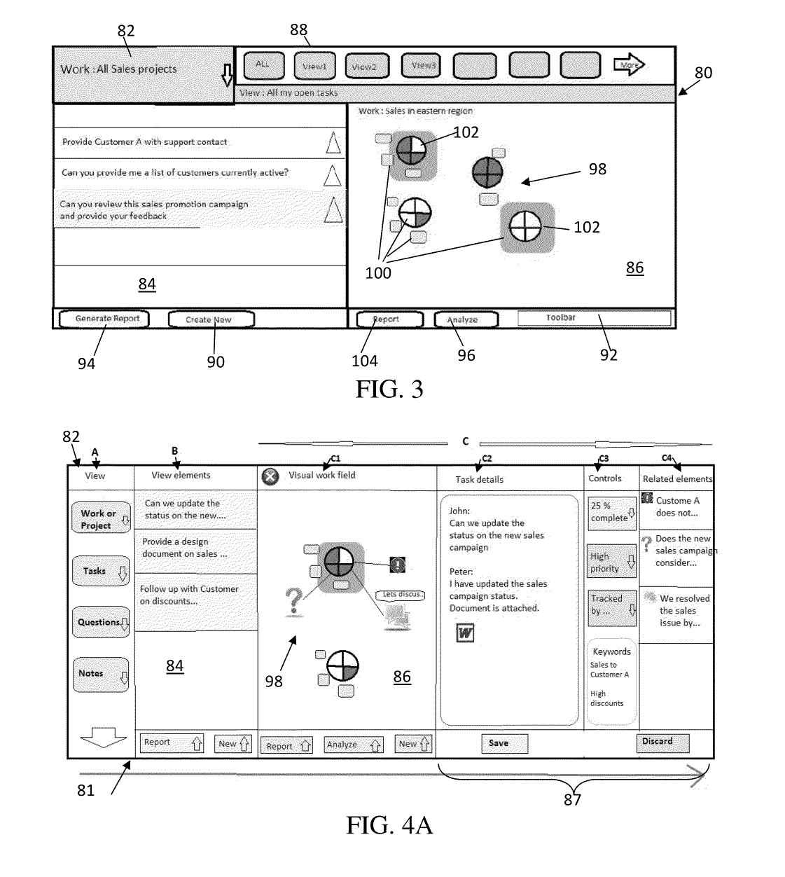

Turning to FIG. 3, FIG. 3 is a simplified diagram of an example GUI 80 viewable through client interface 20. GUI 80 may include at least three distinct regions: 1) a filter region 82; 2) a tabular view region 84; and 3) a spatial view region 86. Filter region 82 may include a filter box for selecting a specific work and a view selector 88, for selecting a specific view. In an example embodiment, the views may appear as clickable (or otherwise selectable) buttons. In the example GUI of the FIGURE, user 15 has decided to see all open tasks that belong to one or more work 22 associated with “All Sales projects” by selecting the appropriate filter parameter in filter region 82.

Tabular view region 84 may include a task list (or work element list) showing a list of tasks (or work elements) based on the selected view. User 15 can scroll through the list of tasks and select a specific work element for viewing in spatial view region 86. In the example shown, user 15 has decided to see all open tasks. Spatial view region 86 may be based on the work element selected in tabular view region 84. Spatial view region 86 my include a display of work elements belonging the filtered work 22 (filtered in filter region 82), and containing the work element selected in tabular view region 84. For example, “All Sales Projects” may include “Sales in eastern region,” which can include “Customer A.” Selecting the work element related to Customer A can cause a display of a single specific work titled “Sales in eastern region” that includes Customer A.

In specific embodiments, filter region 82 can facilitate filtering what user 15 wants to see on GUI 80. Several levels of filtering may be included in filter region 82. For example, a first filtering level is to view work 22 (e.g., all work(s) 22 included in system 10; a custom group of work(s) 22 selected based on keywords or other parameters; or a specific work 22). In one example embodiment, user 15 may be provided with a selection button (e.g., drop down menu) that permits user to select all work(s) 22, or custom work(s) 22, or a specific work 22.

When “ALL” is selected, filtering is turned off, and all work elements associated with substantially all work(s) 22 in system 10 to which user 15 has access may be displayed suitably. When a specific group is selected, work(s) 22 in the selected group may be used to filter the list of work elements that are displayed in tabular view region 84. Alternatively, user 15 can also choose to view an individual work 22. Additionally, user 15 can select a specific view in view selector 88. In some embodiments, filter region 82 may include two filter options: (1) filter work(s) 22; and (2) filter details of selected work(s) 22 to view details, as indicated by view selector 88. For example, a first work selection can include “Work—Sales in Eastern region” and a second view selection can include “View—Open tasks assigned to all my subordinates”. In an example embodiment, the views can be presented as buttons on a top panel. The selected view may simulate a back lighted button, for example, in contrast to other unselected views.

In various embodiments, a wide range of view buttons may be included to facilitate displaying work elements from different view points. Some example views available to specific user A (e.g., when user A logs into system 10) include: “All My tasks” (e.g., substantially all tasks owned by specific user A); “All My subordinates' tasks” (e.g., substantially all tasks assigned to specific user(s) 15 who report directly to specific user A); “All tasks created by Me” (e.g., substantially all tasks created by specific user A); “All Closed tasks since last view” (e.g., substantially all tasks closed by specific user A); “Open Tasks I am tracking” (e.g., substantially all incomplete tasks tracked by specific user A); “All My tracked tasks” (e.g., substantially all tasks owned by specific user A that are tracked by one or more other user(s) 15); “Open Questions assigned to me” (e.g., substantially all unanswered questions assigned to specific user A); “Open Questions I have created” (e.g., substantially all unanswered questions created by specific user A); “New discussions opened in the projects I am tracking” (e.g., discussions generated in work(s) 22 tracked by specific user A); “Issues raised in the last week in the projects I am tracking”; “New insights since last view”; “All insights” (e.g., substantially all insights in a specific work 22); etc.

User(s) 15 can also create custom views and publish them to the organization. The custom views may also appear as buttons in view selector 88. User(s) 15 can search for and select views they are interested in and bring the custom view buttons into their GUI's filter region 82. In many embodiments, an easy to use user interface may be included to show selection criteria for creating custom views. The selection criteria may be presented in a functional manner. User(s) 15 may indicate the data to be presented in the custom view. In many embodiments, the data may not be bound to the view buttons; rather, the selection criteria may be associated with the view button.

For example, vice president User D may wish for a specific view. Sales representative User J can configure the view, test the view and publish the view suitably. Vice president User D can simply search for and select the view (e.g., displayed as a button), make a copy and drag the new button into his top view pane, for example, in view selector 88. When the corresponding view button is selected, relevant data associated with the selected view may be displayed. Although User D and User J may use the same view button, they may see different data. User D has more privileges since he is higher up in the organizational hierarchy and can see the data from his reports. User J can only see the data, to which he has access privileges.

Each user 15 can decide the specific layout of their respective view buttons. For example, user A can place his most used view buttons in his top pane; user B may prefer views like “All open tasks in the project” or “All the tasks I am tracking;” user C may be interested in “All open tasks assigned to me” and “All questions or issues assigned to me;” etc. To illustrate, user A may click on a “Create New” button 90 to create a new work element called “Negotiation” displayed as a new button on GUI 80. User A can drag the new button into a toolbar 92. User A (or another user) can create a custom view that extracts relevant data for “Negotiation.” For example, a view button can be created as “All open Negotiations” or “All Negotiations with issues attached” or “All Negotiations I am part of.” The view buttons may be published and made available across the organization. User(s) 15 can insert the view buttons into the filter pane in view selector 88. Substantially all user(s) 15 can create new “Negotiations” and view data for these “Negotiations.”

User 15 can use toolbar 92 to create work elements. For example, manager User A views an “All open tasks” view, wherein substantially all open tasks, to which manager User A has access privileges, may be displayed. The tasks may span multiple work(s) 22. User A may select one of the open tasks. The selected task may belong to a specific work. In spatial view region 86, substantially all the work elements that belong to the specific work may be displayed. User A may study the tasks and decide to raise an issue and ask a question. User A can use toolbar 92 to select the type of work element (e.g., issue, question) and click on a desired location in spatial view region 86. The appropriate editor for the selected work element may open up. After User A saves the work element, the new work element may be displayed for the specific work.

Embodiments of system 10 can facilitate creating context based work elements. User A could also have created the work element using “Create New” button 90. Work elements created out of context (e.g., using “Create New” button 90) may be placed randomly in spatial view region 86. User A (or other user(s) 15) would then have to move the work element to the desired location on spatial view region 86. On the other hand, when User A creates the work element using toolbar 92 in spatial view region 86, user A can indicate where in spatial view region 86 the work element should be located.

In various embodiments, user 15 can create attachments directly on spatial view region 86. Toolbar 92 may be configured with suitable buttons that opens appropriate editors, including external applications, such as Microsoft Word or image editing software. Each user 15 can also add custom buttons that open preferred applications. The buttons may indicate shortcuts that launch the application associated therewith. In some embodiments, toolbar 92 may be preconfigured with popular applications such as Microsoft word, Paint, Notepad, Microsoft power point, etc. User 15 can also add custom shortcuts as buttons and indicate the full path of the application to be launched. For example, user 15 can click on a button indicating Microsoft Word®. User 15 can click on the desired work element that accepts attachments. Work management engine 18 may launch the application associated with the button. User 15 can compose the document and close the application. The document created by user 15 may be automatically attached to the work element through which the application was launched. When the attachment is saved, the changes are sent to database server 17 for saving in network 12. Thus, other user(s) 15 can view the changes and update accordingly. In some embodiments, user 15 can create the attachment external to work management engine 18, and attach it to the work element through appropriate directives on GUI 80.

A “Generate Report” button 94 can generate a status report based on the selected view. User A hard pressed for time can simply select the view and select (e.g., click, hit, hover mouse over, etc.) “Generate Report” button 94. In some embodiments, selecting “generate report” button 94 can cause work management engine 18 to generate a full report for the view and user A can scan the report for any updates or other details. The report can be further edited by user A, saved, printed or sent via email. User A, or other user(s) 15 can drill into the details and analyze further by selecting an analyze button 96.

Spatial view region 86 can display a spatial view 98 of work 22 that includes a selected work element in tabular view region 84 corresponding to filter parameters selected in filter region 82. Spatial view 98 may include one or more icons 100 corresponding to respective work elements associated with work 22. In some embodiments, the selected work element in tabular view region 84 may be positioned at a center of spatial view region 86. Work elements that correspond to the selected criteria in tabular view region 86 may be highlighted in spatial view 98. For example, icons 102 may be highlighted to indicate that they satisfy the filter and selection parameters of tabular view region 84.

Spatial organization of the work elements can help user(s) 15 at every level in the organizational hierarchy. For example, user A at a relatively higher position in the organizational hierarchy can quickly create tasks or raise questions from the tabular view region 82 and even via email. “Create new” button 90 may be used to create new tasks, questions, discussion, or other appropriate work elements. Another user B at a relatively lower position (than user A) in the organizational hierarchy can arrange and organize the work elements appropriately. When user A logs into system 10 at a later time, the well-organized work elements may be displayed suitably.

Spatial view region 86 can include a “Report” button 104. “Report” button 104 and “analyze” button 96 can provide a substantially “complete” view of work 22 displayed in spatial view region 86, including the status of the various activities in work 22. For example, user A may inspect all open tasks in tabular view region 84, and click on one of the open tasks. Spatial view region 86 may display a visual representation of work 22 associated with the selected open task. User A can select “Report” button 104 to get a full view and report on work 22 displayed in spatial region 86. The report may include tasks running on time, tasks running late, tasks with issues, insights and a full story on work 22. “Analyze” button 96 can cause a display of different views on the work elements. For example, a time-line can show a chronological view of work elements (e.g., work elements arranged in an order of creation time and update time). Analysis of keywords and insights can indicate the relevant keywords or related insights that have relevance to work 22 or the cluster of work elements displayed on spatial view region 86.

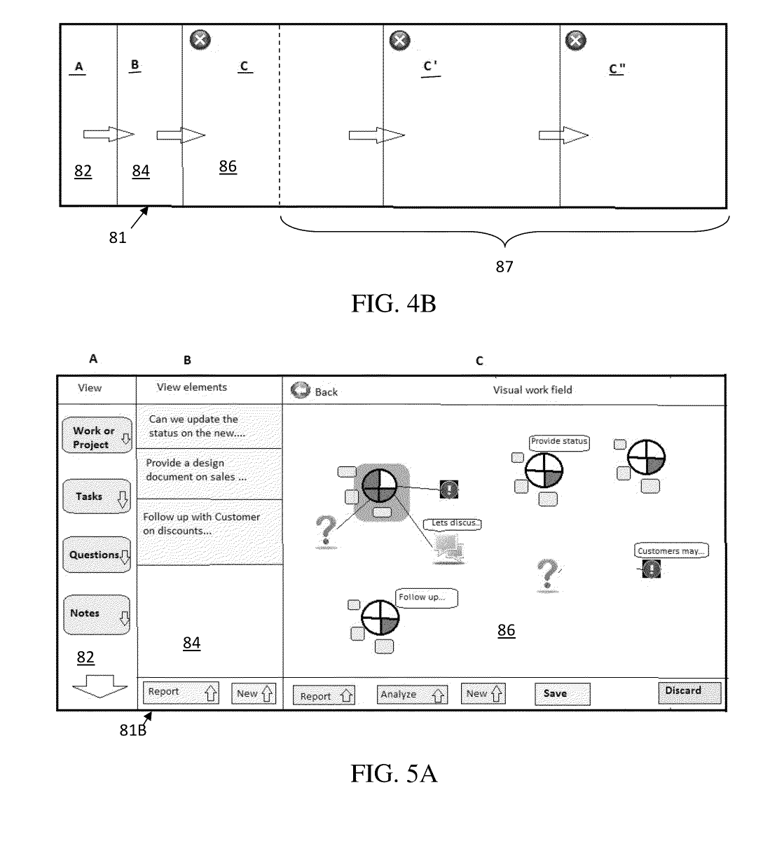

Turning to FIGS. 4A and 4B, FIGS. 4A and 4B are simplified diagrams illustrating another example GUI 81 viewable through client interface 20. GUI 81 may include at least four distinct regions: 1) filter region 82; 2) tabular view region 84; 3) a spatial view region 86; and 4) a work element details region 87. In some embodiments, each region may be arranged in a horizontal contiguous manner, for example, to facilitate scrolling to the right or left (e.g., in devices that support finger swiping or other similar gestures). In other embodiments, each region may be arranged in a vertical contiguous manner, for example to facilitate scrolling up and down (e.g., in devices that support finger scrolling or other similar gestures). Virtually any suitable configuration of the display regions may be included within the broad scope of the embodiments.

Filter region 82 may include a view pane wherein user(s) 15 can filter for a specific work or work element and select the associated view, which may be categorized based on the type of filter. For example, if user 15 selects a box titled “Tasks”, different task related views may be displayed (e.g., as selectable buttons), for example, “Tasks assigned to me,” “Tasks created by me,” “Tasks running late”, “Tasks with high priority,” etc. If user 15 selects a box titled “Questions”, views associated with questions, such as “Questions assigned to me” may be displayed (e.g., as selectable buttons).

Tabular view region 84 may include a task list (or work element list) showing a list of tasks (or work elements) based on the selected view. Spatial view region 86 can display spatial view 98 of work 22 that includes a selected work element in tabular view region 84 corresponding to filter parameters selected in filter region 82. Spatial view 98 includes a display of the work elements and their relationship to other work elements, as appropriate.

Work element details region 87 can include one or more details of the work element corresponding to a selected one of tabular view region 84. For example, if the work element chosen in tabular view region 84 is a task, details associated with the selected task may be displayed in work element details region 87. Work elements detail region 87 may include details such as presented in the example GUI 81, including pane C3 for controls (e.g., including keywords, percentage complete, and other parameters associated with the selected work element), and pane C4 for related work elements (e.g., “attached” elements or “linked” elements; for example, an issue, a question and a discussion, which may be part of the same or different works 22, may linked to the task and may be displayed in pane C4).

According to some embodiments, when user 15 selects one of the related elements in pane C4, a new pane C′ may open up, for example, to the right, as indicated in FIG. 4B. When user 15 selects a related work element in pane C′, another pane C″ may open, for example, on the right of pane C′. When user 15 closes one of the panes in pane C, for example, pane C′ and C″, all the panes to the right may also close. For example, when user 15 closes pane C, panes C′ and C″ may also close; when user 15 closes pane C′, pane C″ may close, but the remaining panes may stay open. When user 15 selects another work element in tabular view region 84, a new set of panes C may open for the selected work element.

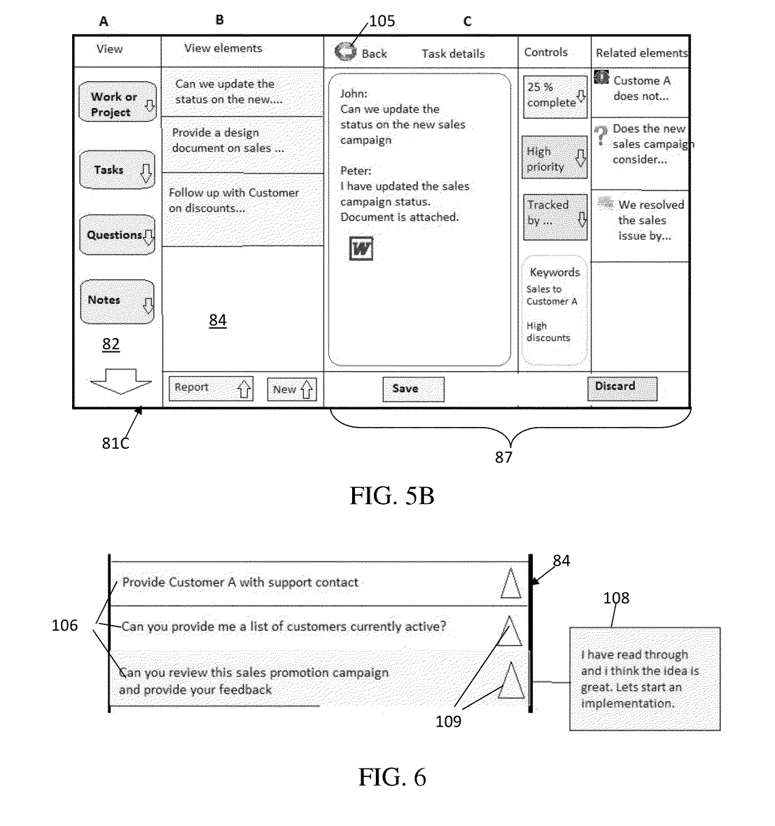

Turning to FIGS. 5A and 5B, FIGS. 5A and 5B are simplified diagrams illustrating another example GUI 81B viewable through client interface 20. GUI 81 may include at least two distinct regions: 1) filter region 82; and 2) tabular view region 84. Filter region 82 may include a view pane wherein user(s) 15 can filter for a specific work or work element and select the associated view, which may be categorized based on the type of filter. Tabular view region 84 may include a task list (or work element list) showing a list of tasks (or work elements) based on the selected view. When user 15 selects a work element from the tabular view region 84, GUI 81B may display spatial view region 86 as shown in FIG. 5A. When user 15 clicks on (or otherwise selects) a work element in spatial view region 86, GUI 81C of FIG. 5B may be displayed. In some embodiments, GUI 81C may be displayed as a pop-up window over GUI 81B. In other embodiments, GUI 81C may be displayed in a separate tab from GUI 81B. In yet other embodiments, GUI 81B may be replaced by GUI 81C on the display screen. A “back” button 105 may be included in GUI 81C (and GUI 81B). When user 15 clicks on (or otherwise selects) back button 105, a previous GUI may be displayed. For example, if user 15 is initially viewing GUI 81B, clicks on a work element in spatial view region 86, and subsequently view GUI 81C, clicking on back button 105 in GUI 81C may close the window that displays GUI 81C, and the previously viewed GUI 81B may be displayed.

When user clicks on (or otherwise selects) a related work element in GUI 81C, appropriate GUI 81B for the selected related work element may be displayed. In some embodiments, filter region 82 and tabular view region 84 may remain unchanged between GUI 81B and GUI 81C. When user 15 selects back button 105 on the newly displayed GUI 81B, the previously viewed GUI 81C may be displayed.

Turning to FIG. 6, FIG. 6 is a simplified diagram illustrating an example tabular view region 84 according to an embodiment of system 10. Client interface 20 may compose a tabular display of data specified by filters and views of filter region 82. For example, user A may specify the view criteria as “Work—Sales in Eastern region” AND “View—Open Tasks assigned to All my subordinates.” The tabular display of data can show open tasks assigned to all of user A's subordinates (e.g., employees reporting to user A). If user A has one thousand reports, then all of the one thousand reports' open tasks may be displayed as a list of records 106. Records 106 in the tabular display may be sorted according to default criteria. User 15 can change the default criteria, for example, by clicking on any of the titles of record 106. As user 15 selects each record 106, a text box 108 may be displayed (e.g., pop up) to indicate a most recent update. Text box 108 with recent update can provide a quick status check on the selected record 106.

To get the more detailed view, user 15 can select icon 109 displayed against corresponding record 106. Selecting icon 109 can open a work element view, which can show a full view (e.g., including substantially all information associated with the work element) or an incremental view (e.g., including information updated since a previous view of the work element).

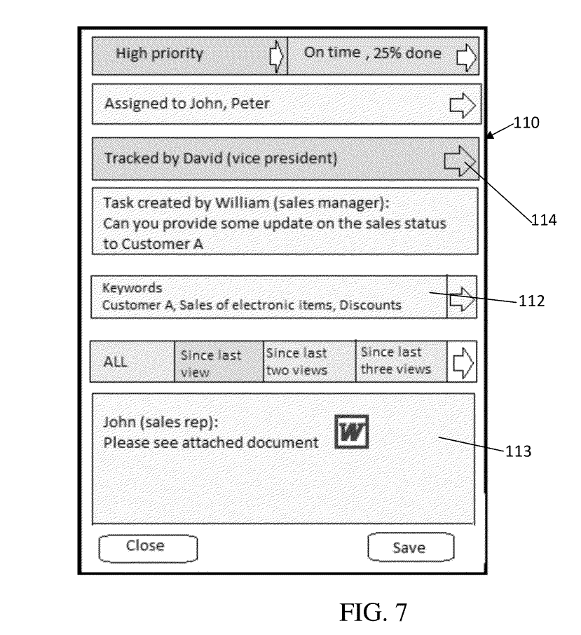

Turning to FIG. 7, FIG. 7 is a simplified diagram illustrating an example task editor 110 according to an embodiment of system 10. Task editor 110 may display relevant parameters for tasks, in general. Task editor 110 may display a full view (e.g., including substantially all information associated with the task), or an incremental view (e.g., including information updated since a previous view of the task). An example incremental view is shown in the FIGURE. User 15 can edit the task based on user 15's edit privileges. Different user(s) 15 may see different incremental views based on when the task was previously viewed. Task parameters in task editor 110 can include: priority, percentage of completion, task details (e.g., what the task is, to whom it is assigned, by whom it is assigned, etc.), relevant keywords 112 and any responses from other user(s) 15 associated with the specific task. In some embodiments, any user 15 with edit privileges can add relevant keywords to the task. The keywords can be used to create or link insights and other work elements. Icons, such as arrows 114 can allow edits, for example, by opening windows that permit more detailed edits.

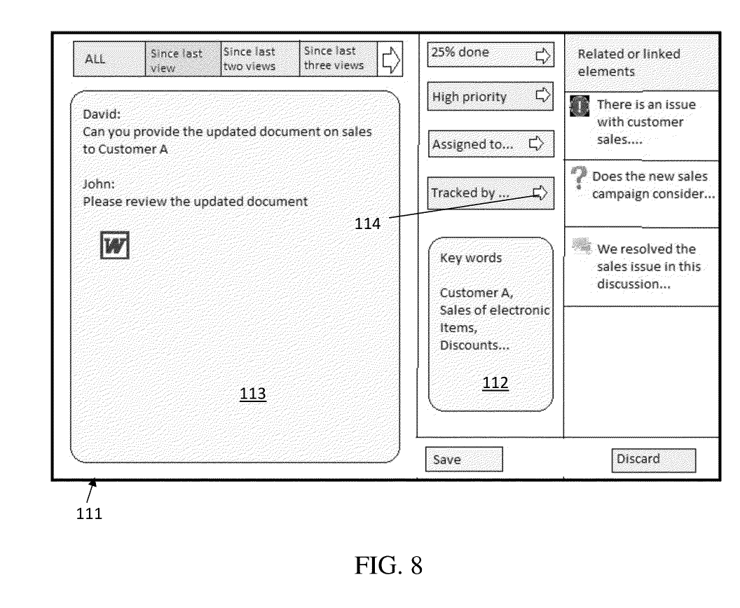

Turning to FIG. 8, FIG. 8 is a simplified diagram illustrating another example task editor 111 according to an embodiment of system 10. Task editor 111 may display relevant parameters for tasks, in general, according to a horizontal layout, for example, to facilitate scrolling the screen from the left to the right (instead of from the top to the bottom). As in example task editor 110, task editor 11 may include relevant keywords 112 and arrows 114. Other details associated with the task may also be included, within the broad scope of the embodiments.

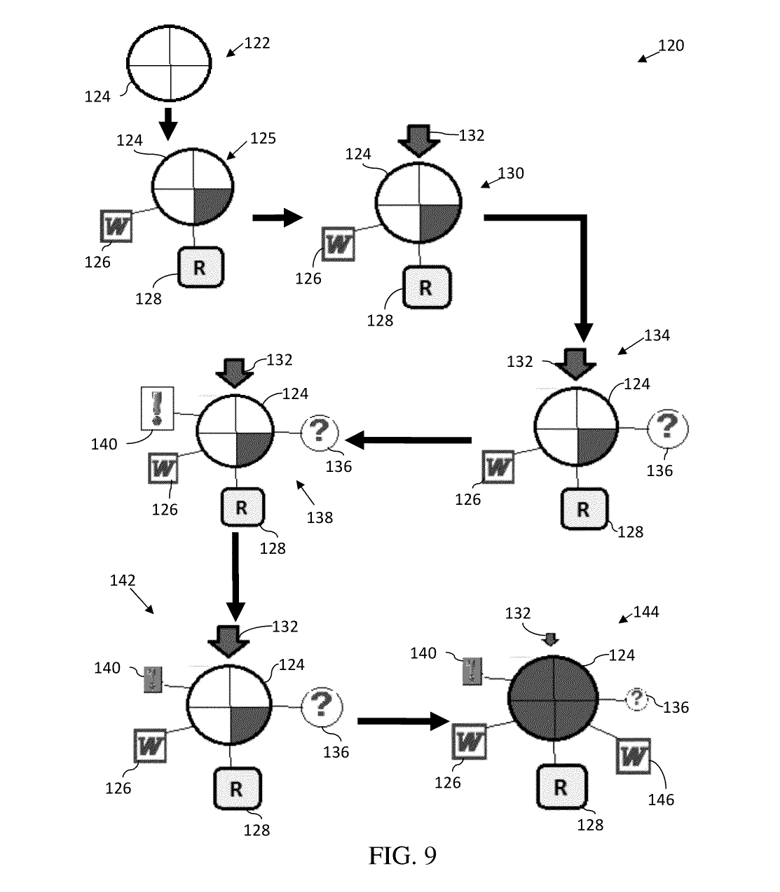

Turning to FIG. 9, FIG. 9 is a simplified block diagram illustrating an example visual representation 120 of a specific task as it evolves in time during the course of progression of the task. At 122, user 15 may create a task represented by icon 124. In many embodiments, icon 124 representing any task may comprise a circle. In a specific embodiment, circle icon 124 may include four quadrants, each representing a quarter of the completion of the task. In the example embodiment illustrated in the figure, when the task is created by user 15, the task is represented as circle 124 with 0% complete status and no attachments. Merely as an example, and not as a limitation, assume that sales manager User W creates task “Can you provide update on customer sales”. The task is assigned to sales representatives User J and User P. When User J and User P log in, they can see the new task assigned to them on their respective client interface 20. The task can be also visible to all higher level managers (e.g., users at relatively higher positions in the organizational hierarch) of User W.

Sales representative User J may provide updates to the task. User J can add his response and also attach a document. User J decides that the document he has attached can represent about 25% of the task. Thus, User J may update the status of the task to 25% (e.g., using task editor 110). The task may appear as illustrated at 125. Attachments and other work elements associated with the task may be represented by respective icons attached (or otherwise linked, or connected) to icon 124. Such attached work elements can include responses to the task, any documents or images associated with the task, any issues or questions raised on the task, or other work elements, as appropriate. For example, icon 126 may represent a Microsoft Word® attachment associated with the task; icon 128 may represent a response associated with the task. In some embodiments, the attachment icons (e.g., 126, 128) may include squares (or rectangles) attached to circle 124. Virtually any suitable icon may be used to represent the work elements within the broad scope of the embodiments.

According to some embodiments, user(s) 15 can open attachments by clicking on (or otherwise selecting) the attachments. The attachments may also be opened using editor panes, or toolbar 92. Clicking on the attachment may open the attachment in the relevant editor available on client 14. Any changes made to the attachment may be saved into system 10. For example, User J can create a document, which User P can later edit. Data is not stored on client 14; rather, the data is sent to middle server 16 and the middle server saves the data in its data layer or in back end database server 17.

At 130 (e.g., a later time), vice president User D may begin to track the task. A tracking icon 132 may be associated with the task. At 134, manager User W may request a status update on the task, as indicated by icon 136. At 138, sales representative User J may raise an issue on the task, represented by icon 140. The issue may indicate, for example, that the customer contact is suddenly unavailable. User(s) 15 working on the specific work with which the task is associated may see the issue and can understand the status of the task. For example, vice president User D can see the issue and can click (or otherwise select) icon 140. The issue description by sales representative User J may be displayed in response to the selection of icon 140, permitting vice president User D to take appropriate action.

At 142, the issue may be resolved, as indicated by a graying out of icon 140. The history and details of the issue may not be lost. Grayed out icon 140 can indicate that the represented issue is not current (or relevant) any more. If the same issue reappears at a later time, icon 140 may be selected, the issue re-opened (e.g., using an appropriate editor), or a new issue can be attached to the task. At 144, the icons may indicate that the task is complete. For example, the status request indicated by icon 136 may be closed, and represented as a smaller size icon 136. The four quadrants of icon 124 may be shaded completely to indicate that 100% of the task is complete. Tracking icon 132 may be displayed in smaller size to indicate that the task is not tracked any more. Sales representative User P may attach an additional document to the task, represented by icon 146.

According to various embodiments, visual representation 120 of each task can allow for a succinct summary of each task displayed in a visually pleasing manner, with minimal textual details to prevent clutter and contextual information on each task. In various embodiments, user(s) 15 can view an entire work field with one or more tasks and other work elements displayed as distinct icons. User(s) 15 can in generate a “story” from the tasks, complete with details of all activities, information and documents associated with the task. Visual representation 120 can allow related tasks to be clustered, for example, to provide meaning and context to each task. Clustering of tasks can provide additional meaning to the tasks, for example, by facilitating creation of insights.

In many embodiments, navigation helpers can appear in visual representation 120. User 15 can quickly navigate to any area on the GUI based on a title or task keyword, or insight, or other suitable parameter. Fields may be dragged to appropriate locations on the GUI for navigation purposes. Global searches for titles, tasks, insights and keywords (among other parameters) can help user(s) 15 in quick navigation.

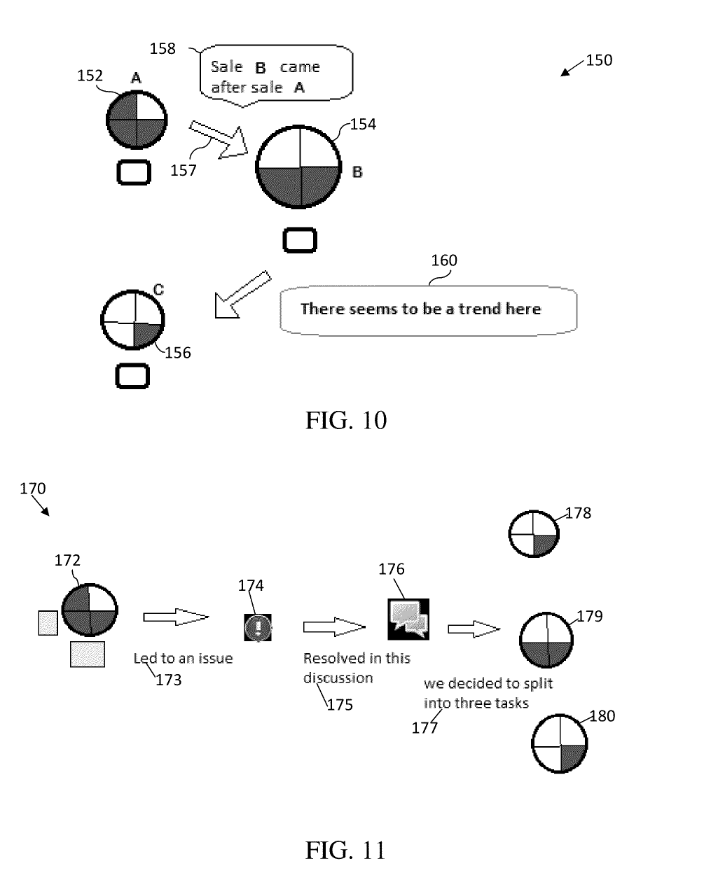

Turning to FIG. 10, FIG. 10 is a simplified diagram illustrating an example visual representation 150 associated with an embodiment of system 10. Imagine that an organization makes sales to many customers. Each sale may be represented as a circular icon; sales to a specific customer can be clustered together as appropriate. For example, sales A, B, and C to customer Z can be represented as icons 152, 154 and 156. Arrows 157 may be placed between icons 152, 154 and 156 to indicate the time line or other information of the sales. Labels 158, 160 may be inserted to provide further context. For example, sales representative user J is assigned the task to sell electronic items to Customer Z. User J sees that the work also involves sales of other items to Customer Z. User J decides to place his new task next to the tasks relating to sales to Customer Z. The GUI allows User J to cut and paste or move or drag the task across the display.

User J may place his task B, represented as icon 154 next to another task A represented as icon 152. Icon 154 may appear bigger than icon 152 for User J because the task represented by icon 154 may have been created by a person higher up in the organizational hierarchy. User J can place arrow 157 and label 158 to indicate that his task represented by icon 154 came later in time compared to task A, represented by icon 152. Other user(s) 15 looking at the work can clearly see that the task represented by icon 154 was created after the task represented by icon 152. At a later time, User J may create another task C, represented by icon 156. Later, when manager User W studies the tasks, he notices that there is some pattern in the buying behavior for Customer A. User W may insert label 160 relevant to the tasks indicated by icons 152, 154 and 156, for example, indicating: “there seems to be a trend here.”

Turning to FIG. 11, FIG. 11 is a simplified diagram illustrating an example visual representation 170 according to an embodiment of system 10. User(s) 15 can spatially organize icons 172, 174, 176, etc. representing respective work elements to compose a story (e.g., chronological arrangement of work elements indicating a coherent narrative). For example, Task1 represented by icon 172 may lead (as indicated by label 172) to an issue represented by icon 174, which may be resolved (as indicated by label 175) through a discussion represented by icon 176. During the discussion, user(s) 15 may decide to split Task1 into three tasks (as indicated by label 177), represented respectively by icons 178, 179 and 180. Other user(s) 15 viewing the work field can understand the sequence of events that took place leading from Task1 to the three separate tasks.

According to some embodiments, work management engine 18 may not strictly enforce display of the work elements in a chronological order. Rather, icons representing the work elements are configurable to be arranged according to the chronological order according to at least two mechanisms. A first mechanism facilitates displaying the work elements in the chronological order according to a specifically configured view (e.g., view configured as “All tasks in a chronological order”). In the specifically configured view, as selected by user 15, the work elements may be displayed in spatial view region 86 in the chronological order. In another example, the specifically configured view may enable display of tasks that are running late, arranged in the chronological order (e.g., “All my tasks that are running late in a chronological order”). Yet another example includes a specifically configured view wherein certain types of questions are arranged in the chronological order (e.g., spatial view region 86 “All questions raised by my direct reports in the last month in a chronological order”). Various other configurations are possible for the views to display work elements in the chronological order; all such configurations are included within the broad scope of the embodiments.

A second mechanism for viewing the work elements in the chronological order includes facilitating user(s) 15 to manually arrange (e.g., by dragging and dropping the icon at a preferred location on the display screen, etc.) the work elements in spatial view region 86 in the chronological order of choice. For example, a task may be created by user 15. A question may be later raised on the task. A discussion regarding the question may follow. The three work elements (e.g., task, question and discussion) can be arranged from left to right with suitable labels and arrows to show the chronological order of the work elements. In various embodiments, work management engine 18 can facilitate flexibly arranging the work elements on spatial view region 86 according to the users' particular needs and desires.

Turning to FIG. 12, FIG. 12 is a simplified diagram illustrating an example visual representation 190 according to an embodiment of system 10. Assume, merely for the sake of illustration and not as a limitation that User P views a task represented by icon 192. The task may have been created by User P or another user. User P may analyze the apparent trends and place an insight represented by icon 194 and label 196 next to icon 192. Other user(s) 15 viewing the task can read User P's insight.

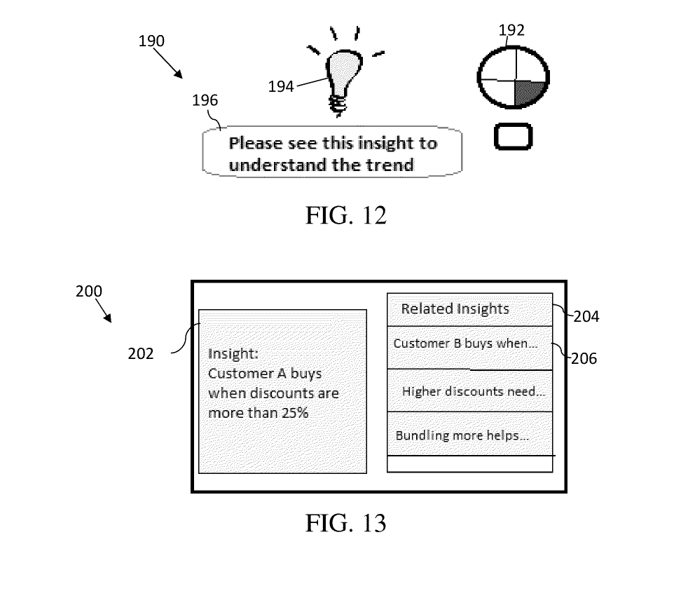

Turning to FIG. 13, FIG. 13 is a simplified diagram illustrating an example insight editor 200 according to an embodiment of system 10. When User P creates insight 202, work management engine 18 may search for any potentially related insights 204 and display a list of potentially related insights 204 in insights editor 200. User P can inspect the list and decide whether or not to include any of the listed insights as being related to insight 202. Work management engine 18 may find potentially related insights 204 based on keywords identified in insights stored previously, for example, in knowledge database 62. Based on User P's selection of related insights, work management engine 18 may create two way links to both insights (e.g., insight 202 and related insight). For example, insight 202 may indicate “Customer A buys when discounts are more than 25%.” A potentially related insight 206 may indicate “Customer B buys when discounts are more than 20%.” User P may indicate that insight 206 is related to insight 202. If User P were to open insight 206, User P can see related insight 202 in the respective insight editor. Substantially all user(s) 15 with appropriate access privileges can open the insights and related insights and study the trends involved. Eventually, the linked chain of insights can enhance a knowledge base of the organization.

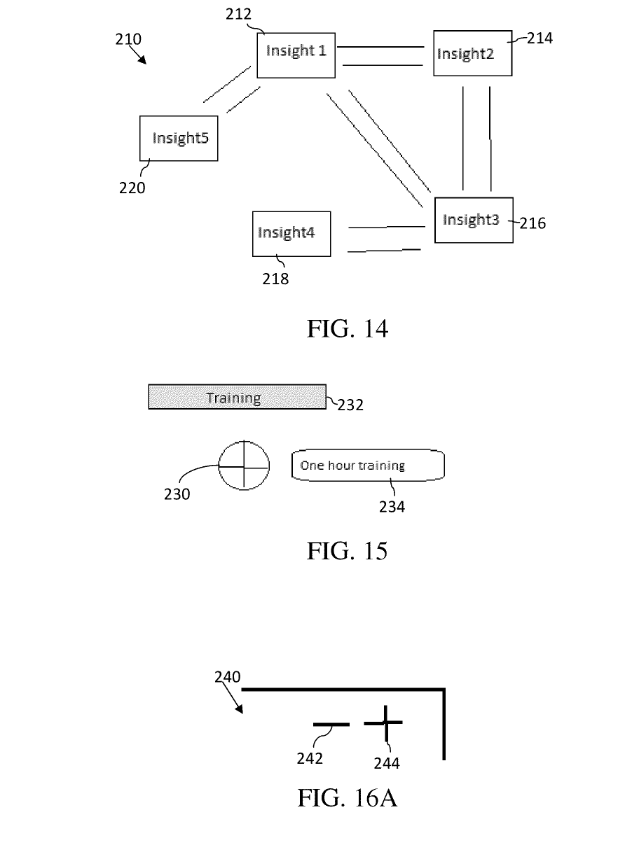

Turning to FIG. 14, FIG. 14 is a simplified diagram illustrating an example set 210 of linked insights according to an embodiment of system 10. Assume, merely for example purposes, and not as a limitation, that User J inserts insight 212 (insight1) indicating, “Customer B buys when discounts are more than 20%”. Later (or substantially simultaneously), User P adds another insight 214 (insight2) indicating, “Customer A buys when discounts are more than 25%” and adds User J's insight 212 as a related insight. Work management engine 18 may add User P's insight 214 as a linked insight in User J's insight 212. If User J were to open insight 214, he can see User P's insight 212 as a related insight. Similarly, insights 214, 216, and 218 may be linked appropriately. Insight 220 may be linked to insight 212, but may not be related to other insights, and therefore, may not be linked accordingly.

Work management engine 18 can facilitate browsing from one insight to another related insight using appropriate links (e.g., also referred to as “surfing.”). For example, User J can navigate to User P's insight 212 and search and look at more related insights in an example embodiment. Insight surfing can aggregate significant information and knowledge in the organization. In another example, a senior vice president (e.g., user high up in the organizational hierarchy) can look at the insights growing in the organization. In an example embodiment, a view button may be configured to present substantially all insights in a list form. The senior vice president can add other insights to the list using suitable insight editors. The insights may be made visible to other user(s) 15 in the organization. This in turn is visible to others in the organization. Thus, planning and executing tasks can provide insights and knowledge to the organization. User(s) 15 can learn from experience indicated by relevant insights. By capturing different aspects of knowledge gained from experience in the form of insights, a coherent and valuable story can be developed.

Turning to FIG. 15, FIG. 15 is a simplified diagram illustrating example details of an embodiment of system 10. Work management engine 18 can facilitate placing titles in the GUI. For example, user A may join the organization. The manager user B creates a new task, indicated by icon 230, assigned to user B and the employee user A. The new employee user A can see the new task represented by icon 230 at log-in into system 10. User A can create a title 232, for example, entitled “Training” and place icon 230 next to it. When the manager user B (or other user(s) 15) logs in to system 10, title 232 may be displayed next to icon 230. The manager user B can attach documents or other work elements near title 232; for example, a label 234 indicating the nature of the task. The area around title 232 can indicate a location in the GUI to attach other related work elements, such as tasks, documents, discussions, questions and insights. Within this work's field view, user(s) 15 can navigate based on title 232.

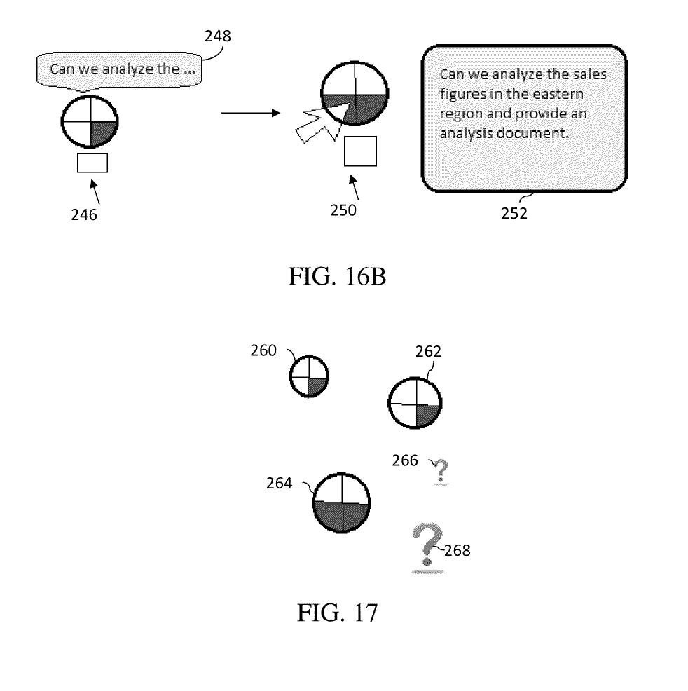

Turning to FIGS. 16A and 16B, FIGS. 16A and 16B are simplified diagrams illustrating example zoom features 240 of an embodiment of system 10. Zoom feature 240 may be included in spatial view region 86. Example zoom feature 240 may include a zoom minimizer 242 and a zoom maximizer 244. According to various embodiments, when the zoom reaches a maximum position, for example, by selecting zoon maximizer 244 until a maximum zoom position is reached, the work elements show a part of their relevant content for quick view. When the work element is zoomed out, for example, by selecting zoon minimizer 242 until a minimum zoom position is reached, the content is not displayed. In between the maximum and minimum zoom positions, part of the content may be displayed suitably. In some embodiments, to see more of the content, user 15 can simply hover a mouse pointer on top of the work element; a portion of details of the work element may be displayed thereupon. To see substantially all details, user 15 may click on (or otherwise select) the work element, which action may cause the relevant editor to open and display the contents of the work element.

An example of zoom feature 240 is illustrated in FIG. 16B. At 246, a portion of label 248 may be displayed depending on the zoom position. At 250, the specific work element has been zoomed in using zoom maximizer 244, and label 248 may be expanded to 250 to display more content.

Turning to FIG. 17, FIG. 17 is a simplified diagram illustrating example details of an embodiment of system 10. According to embodiments of system 10, work management engine 18 can cause a display of work elements as icons of varying size depending on the relative importance of the respective work elements. In some embodiments, the relative importance may be based in the organizational hierarchy. According to a default state, substantially all work elements may be displayed as corresponding icons of a standard size. If the work element is created by User A higher up in the organizational hierarchy than a viewing User B, the work element may be represented by an icon that is larger than the default size.

For example, icon 260 may represent a work element created by user A. Icon 260 may be displayed according to a default size. Icon 262 may represent another work element created by User B, who is higher than User A in the organizational hierarchy. Icon 262 may be displayed in a size that is larger than icon 260. Icon 264 may represent another work element created by User C, who is higher than User B in the organizational hierarchy. Icon 264 may be displayed in a size that is larger than icon 262. When User B sees the same three work elements, the representative icons may be of different sizes than what is seen by User A. For example, the work element represented by icon 260 may be shown smaller than standard size for User B in some embodiments. In other embodiments, the work element represented by icon 260 may be shown in the standard size for User B. When User C sees the same three work elements, all icons may be smaller than (or the same size as) the standard size. In some embodiments, the icon sizes may be represented in three sizes (e.g., standard, bigger, and biggest). Various other icon sizes may be included within the broad scope of the embodiments.

Similarly, icon 266 representing another work element may be of standard size, indicating that it was created by a user in the same position as User A in the organizational hierarchy; icon 268 representing yet another work element may be larger than standard size, indicating that it was created by a user higher up in the organizational hierarchy than User A. The size of the icons may be based on a relative position of the creator of the corresponding work element in the organizational hierarchy. Other criteria, such as priority, may also be included. For example, the size of the icons may be indicating of a priority of the respective work element, with higher priority indicated by larger icons.

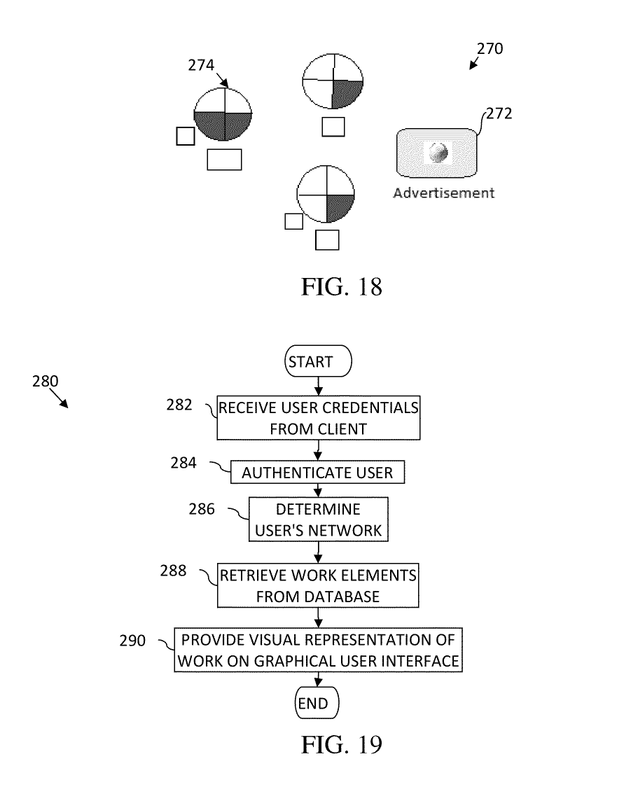

Turning to FIG. 18, FIG. 18 is a simplified diagram illustrating example details a task based advertisement 270 of an embodiment of system 10. In the illustrated embodiment, advertisement 270 may be placed proximate related work elements 274. In some embodiments, work management engine 18 may be available as a paid model (e.g., paid through user subscriptions), as a free model (e.g., paid through sponsored advertisements), or as a combination thereof. In free model, users 15 may see advertisement 272 in spatial view region 86.

Work management engine 18 may store one or more advertisement, or may retrieve such advertisements from the corresponding sponsor across a network. Work management engine 18 may scan tasks or clusters of tasks and keywords and place relevant advertisement(s) 272 at strategic locations on spatial view region 86. For example, if the tasks relate to sales, the advertisement could be for a sales tool. If the tasks relate to Customer A, the advertisement could be from Customer A, perhaps for a product Customer A sells. If users re-orient the tasks, the initial advertisement can be removed automatically. In some embodiments, advertisement 272 may be dynamic, changing with every view refresh. In some embodiments, advertisement 272 may change from day to day (or user to user, or both). Advertisement 272 may be selected dynamically by middle server 16 when client queries are received. Advertisement 272 may be tailored to user 15, the time of day, relevance of the advertisement in general, or other suitable parameter.

Turning to FIG. 19, FIG. 19 is a simplified flow diagram illustrating example operations 280 that may be associated with embodiments of system 10. At 282, work management engine 18 may receive user credentials (e.g., user name, password, etc.) of user 15 from client 14. At 284, work management engine 18 may authenticate user 15. At 286, work management engine 18 may determine user 15's network (e.g., including relative position in the organizational hierarchy). At 288, work management engine 18 may retrieve appropriate work elements from a database (e.g., knowledge database 62). At 290, work management engine 18 may provide a visual representation of work 22 on a suitable GUI.

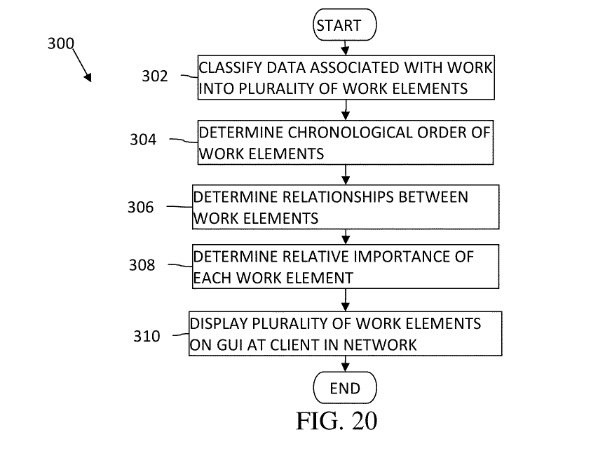

Turning to FIG. 20, FIG. 20 is a simplified flow diagram illustrating example operations 300 that may be associated with embodiments of system 10. At 302, work management engine 18 may classify data associated with work 22 into a plurality of work elements. At 304, work management engine 18 may determine a chronological order of the work elements. At 306, work management engine 18 may determine relationships between the work elements. At 308, work management engine 18 may determine a relative importance of each work element to a viewer. At 310, work management engine 18 may cause a display of the plurality of work elements on a suitable GUI at client 14 in network 12.

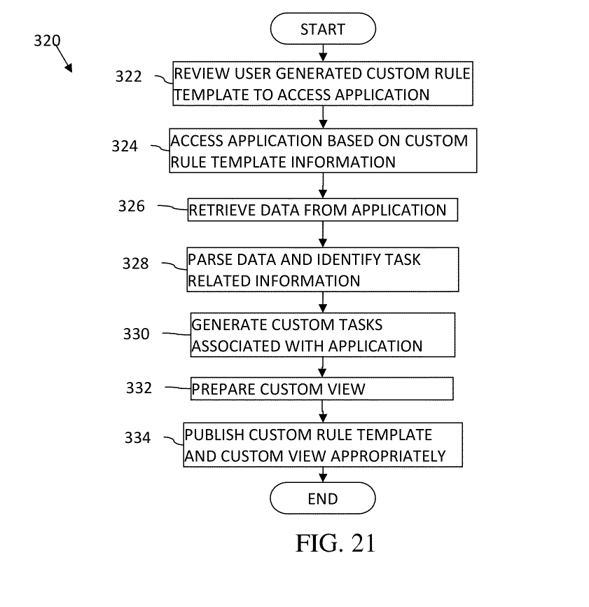

Turning to FIG. 21, FIG. 21 is a simplified flow diagram illustrating example operations 320 that may be associated with an embodiment of system 10. At 322, rule module 63 may review user-generated custom rule template(s) to access application 64, external to work management engine 18. At 324, rule module 63 may access application 64 based on the custom rule template. At 326, rule module 63 may retrieve data from application 64. At 328, rule module 63 may parse the data and identify task related information. At 330, rule module 63 may generate custom tasks associated with application 64. At 332, work management engine 18 may prepare a custom view of the custom tasks. At 334, work management engine 18 may publish the custom rule template and custom view appropriately to other user(s) 15.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. An “application” as used in this Specification, can be inclusive of an executable file comprising instructions that can be understood and processed on a computer, and may further include library modules loaded during execution, object files, system files, hardware logic, software logic, or any other executable modules.

In example implementations, at least some portions of the activities outlined herein may be implemented in software in, for example, work management engine 18. In some embodiments, one or more of these features may be implemented in hardware, provided external to these elements, or consolidated in any appropriate manner to achieve the intended functionality. The various network elements (e.g., work management engine 18, servers 16 and 17, clients 14, etc.) may include software (or reciprocating software) that can coordinate in order to achieve the selection and placement operations as outlined herein. In still other embodiments, these elements may include any suitable algorithms, hardware, software, components, modules, interfaces, or objects that facilitate the operations thereof.

Furthermore, work management engine 18 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 26) can store data used for the operations described herein. This includes the memory element being able to store instructions (e.g., software, logic, code, etc.) in non-transitory computer readable media such that the instructions are executed to carry out the selection and placement activities described in this Specification. The memory elements may further keep information in any suitable type of non-transitory computer readable storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in system 10 could be provided in any database, register, table, cache, queue, control list, or storage structure, based on particular needs and implementations, all of which could be referenced in any suitable timeframe. Any of the memory items discussed herein should be construed as being encompassed within the broad term “memory element.”

Similarly, any of the potential processing elements, modules, and machines described in this Specification should be construed as being encompassed within the broad term “processor.” A processor can execute any type of instructions associated with the data to achieve the operations detailed herein in this Specification. In one example, processors (e.g., processor 28) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In various embodiments, logic may be encoded in one or more non-transitory computer readable media that includes instructions for execution by the processor and operable to perform the operations described herein.

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, system 10 may be applicable to other exchanges or routing protocols. Moreover, although system 10 has been illustrated with reference to particular elements and operations that facilitate the communication process, these elements, and operations may be replaced by any suitable architecture or process that achieves the intended functionality of system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
classifying data associated with a work into a plurality of work elements, wherein the work includes a software implementation of a collection of activities, information, and documents that together contribute to an overall business goal;
determining a chronological order of the work elements, comprising identifying a time of creation of each work element;
determining relationships between the work elements;
determining a relative importance of each work element; and
displaying the plurality of work elements as distinct icons on a graphical user interface (GUI) at a client in a network environment, wherein the icons are configurable to be arranged according to the chronological order to indicate a story, wherein related work elements are clustered together, wherein work elements with relatively higher importance are displayed as relatively larger icons.

2. The method of claim 1, wherein the display includes a spatial view and a tabular view of the work elements.

3. The method of claim 1, wherein types of work elements comprise titles, tasks, insights, and at least one selection from a group consisting of: attachments, questions, issues, discussions, notes, and links, wherein each type of work element is associated with a respective icon.

4. The method of claim 3, wherein each task is displayed as a circular icon, shaded according to a percentage of completion, with associated work elements indicated as respective icons connected to the circular icon.

5. The method of claim 3, wherein the insights are associated with one or more tasks and linked according to keywords in the tasks.

6. The method of claim 3, wherein each type of work element is created using a respective editor on the GUI.

7. The method of claim 6, wherein a discussion editor can be edited substantially simultaneously by a plurality of users, wherein a notes editor can be edited by one user at any specific instant, wherein a question editor can be edited by at least two users, and wherein an issues editor can be edited by at least two users.

8. The method of claim 1, wherein the display is filtered to show work elements associated with a specific user, wherein the relative importance of the work elements are based on a relative position of the specific user in an organizational hierarchy, wherein work elements created by users higher in the organizational hierarchy are more important than work elements created by users lower in the organizational hierarchy.

9. The method of claim 8, wherein a default size of the icons is based on the relative position of the specific user in the organizational hierarchy.

10. The method of claim 1, wherein the display includes a zoom function, wherein when the display is zoomed in, the work elements show a portion of their respective content, wherein selecting the portion of a specific work element generates a more detailed view of the corresponding content.

11. The method of claim 1, wherein the display can be configured by a user to filter one or more details of the work elements.

12. The method of claim 1, wherein the relationships between the work elements are based on keywords associated with the respective work elements.

13. Logic encoded in one or more non-transitory computer readable media that includes instructions for execution and when executed by a processor, is operable to perform operations, comprising:
classifying data associated with a work into a plurality of work elements, wherein the work includes a software implementation of a collection of activities, information, and documents that together contribute to an overall business goal;
determining a chronological order of the work elements, comprising identifying a time of creation of each work element;
determining relationships between the work elements;
determining a relative importance of each work element; and
displaying the plurality of work elements as distinct icons on a GUI at a client in a network environment, wherein the icons are configurable to be arranged according to the chronological order to indicate a story, wherein related work elements are clustered together, wherein work elements with relatively higher importance are displayed as relatively larger icons.

14. The media of claim 11, wherein the display is filtered to show work elements associated with a specific user, wherein the relative importance of the work elements are based on a relative position of the specific user in an organizational hierarchy, wherein work elements created by users higher in the organizational hierarchy are more important than work elements created by users lower in the organizational hierarchy.

15. The media of claim 11, wherein the relationships between the work elements are based on keywords associated with the respective work elements.

16. The media of claim 11, wherein types of work elements comprise titles, tasks, insights, and at least one selection from a group consisting of: attachments, questions, issues, discussions, notes, and links, wherein each type of work element is associated with a respective icon.

17. An apparatus, comprising:
a memory element for storing data; and
a processor that executes instructions associated with the data, wherein the processor and the memory element cooperate such that the apparatus is configured for:
classifying data associated with a work into a plurality of work elements, wherein the work includes a software implementation of a collection of activities, information, and documents that together contribute to an overall business goal;
determining a chronological order of the work elements, comprising identifying a time of creation of each work element;
determining relationships between the work elements;
determining a relative importance of each work element; and
displaying the plurality of work elements as distinct icons on a GUI at a client in a network environment, wherein the icons are configurable to be arranged according to the chronological order to indicate a story, wherein related work elements are clustered together, wherein work elements with relatively higher importance are displayed as relatively larger icons.

18. The apparatus of claim 17, wherein the display is filtered to show work elements associated with a specific user, wherein the relative importance of the work elements are based on a relative position of the specific user in an organizational hierarchy, wherein work elements created by users higher in the organizational hierarchy are more important than work elements created by users lower in the organizational hierarchy.

19. The apparatus of claim 17, wherein the relationships between the work elements are based on keywords associated with the respective work elements.

20. The apparatus of claim 17, wherein types of work elements comprise titles, tasks, insights, and at least one selection from a group consisting of: attachments, questions, issues, discussions, notes, and links, wherein each type of work element is associated with a respective icon.
